(19) United States
(12) Patent Application Publication
(10) Pub. No.: US 2015/0031846 A1
(43) Pub. Date: Jan. 29, 2015

(54) POLYMERS HAVING CHELATING FUNCTIONALITY

(71) Applicants: Dow Global Technologies LLC, Midland, MI (US); Rohm and Haas Company, Philadelphia, PA (US)

(72) Inventors: Scott Backer, Philadelphia, PA (US); Allen Bulick, Lansdale, PA (US); Joseph Manna, Quakertown, PA (US); Cynthia Rand, Sanford, MI (US); Jia Xie, Lake Jackson, TX (US)

(73) Assignees: ROHM AND HAAS COMPANY, Philadelphia, PA (US); DOW GLOBAL TECHNOLOGIES LLC, Midland, MI (US)

(21) Appl. No.: 14/354,616

(22) PCT Filed: Oct. 31, 2012
(86) PCT No.: PCT/US2012/062675

§ 371 Date: Apr. 28, 2014

Related U.S. Application Data
(60) Provisional application No. 61/553,626, filed on Oct. 31, 2011.

(51) Int. Cl. C08F 220/06

(52) U.S. Cl. CPC C08F 220/06
USPC 526/312

(57) ABSTRACT

The present invention provides novel polymers having chelating functionality and comprising units derived from a vinyl aminocarboxylate monomer which comprises units derived from iminodiecetic acid, iminodisuccinic acid, or a salt thereof, and a vinyl epoxy benzene monomer.

### FIELD OF THE INVENTION

The present invention relates to novel polymers having chelating functionality and comprising units derived from a vinyl aminocarboxylate monomer. The ethylenically unsaturated aminocarboxylate monomer comprised units derived from iminodiecetic acid, iminodisuccinic acid, or a salt thereof, and divinylbenzene monoepoxide.

### BACKGROUND OF THE INVENTION

Synthetic detergents typically consist of a dispersant, a builder, and other miscellaneous ingredients such as brighteners, perfumes, anti-redeposition agents and enzymes. The dispersant typically comprises a surfactant and functions to separate dirt, soil and stains from fabric and other substrates. Polyacrylates are well known and commonly used dispersant compounds. The builder binds with and forms a complex with metal cations, such as calcium and magnesium ions found in “hard water,” which otherwise interfere with the dispersant activity. Such binding and complex formation is also commonly referred to as “chelating” and compounds capable of such interaction with metal ions are known as “chelating agents.”

Phosphates are excellent chelating agents, which is why they were historically used as builders for detergents. However, even after wastewater treatment, large amounts of phosphorus found their way into streams, rivers, lakes and estuaries. In natural water bodies, phosphorous acts as a fertilizer, increasing growth of algae and aquatic weeds, which depletes the amount of oxygen available for healthy fish and aquatic life, whose numbers then decrease. Consequently, most jurisdictions have limited or banned the use of phosphates in detergents.

In the search for phosphate substitutes, amino carboxylate compounds have been found to be effective chelating agents and, therefore, useful as builders for laundry and automatic dishwashing detergents. For example, U.S. Pat. No. 3,331,773, teaches preparation of water soluble polymers having chelating functionality by grafting water soluble chelating monomers onto water soluble polymers. Diethylenetriamine, ethylenediamine tetraacetic acid, and other polyalkylene polyamine polyacetic acids are identified as examples of chelating monomers suitable for grafting onto water soluble polymers.

U.S. Pat. No. 5,514,732 also describes contact lenses made from water insoluble polymers having chelating functionality. The polymers are made from aminopolycarboxylic acids with a polymerizable olefinic group, as well as a hydrophilic monomer and one or more crosslinking monomer.

U.S. Patent Application No. 2008/00262192 describes an water-soluble polymer having a high chelating performance and clay dispersancy which is made by polymerizing an amino group-containing allyl monomer derived from adding an amine compound, such as iminodiacetic acid (IDA), to an allyl monomer, such as allyl glycidal ether (AGE). Also according to U.S. Patent Application No. 2008/00262192, the amino group-containing allyl monomer may be polymerized with other polymerizable monomers including, without limitation, unsaturated monocarboxylic acid monomers.

U.S Patent Application No. 2009/0082242 discloses a phosphate free dish washing liquor comprising exfoliated nanoclay, a clay-dispersing polymer, as well as other components including known chelating agents such as nitrilotriacetates (NTA), ethylene diamine tetraacetate (EDTA), propylene diamine tetraacetic acid, (PDTA), ethylene diamine N,N′-disuccinic acid (EDDS) and methyl glycine diacetic acid (MGDA), or their salts.

The present invention provides novel polymerizable monomer compounds which have chelating functionality, as well as polymers made therefrom which shall be useful in aqueous systems for scale inhibition, soil removal, tea destaining, particulate dispersion and metal ion binding.

### SUMMARY OF THE INVENTION

The present invention is a polymer having chelating functionality and comprising units derived from (a) an ethylenically unsaturated aminocarboxylate monomer having one or more of the following structures:

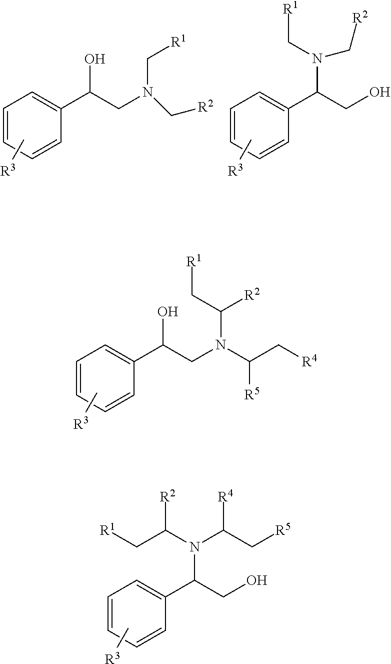

wherein R¹ is COOX¹, R² is COOX², R⁴ is COOX⁴ and R⁵ is COOX⁵; X¹, X², X⁴, X⁵ are each, independently, hydrogen or a mono- or polyvalent cation and the total charge on the monomer is zero; and R³ is a polymerizable ethylenically unsaturated group located at the ortho-, para-, or meta- substituted position of the benzene ring. In some embodiments, R³ is —CH═CH₂.

The polymer may further comprise one or more ethylenically unsaturated monomers. The polymer of the present invention may comprise (a) 0.5-99.5%, by weight, of the ethylenically unsaturated aminocarboxylate monomer, and (b) 99.5-0.5%, by weight, of the one or more ethylenically unsaturated monomers, based on the total weight of the polymer.

### DETAILED DESCRIPTION OF THE INVENTION

All percentages stated herein are weight percentages (wt %), unless otherwise indicated.

Temperatures are in degrees Celsius (° C.), and ambient temperature means between 20 and 25° C., unless specified otherwise.

Weight percentages of monomers are based on the total weight of monomers in the polymerization mixture from which the subject polymer is produced.

All polymer T_{g} values were measured by differential scanning calorimetry (DSC), using a heating rate of 10° C. per minute with the T_{g} taken at the midpoint of the transition.

The term “polymerized units derived from” as used herein refers to polymer molecules that are synthesized according to polymerization techniques wherein a product polymer contains “polymerized units derived from” the constituent monomers which are the starting materials for the polymerization reactions.

“Polymer” means a polymeric compound or “resin” prepared by polymerizing monomers, whether of the same or different types. The generic term “polymer,” as used herein, includes the terms “homopolymer” and “copolymer.” For example, homopolymers are polymeric compounds which have been prepared from a single type of monomer. Copolymers, as this term is used herein, means polymeric compounds prepared from at least two different types of monomers. For example, an acrylic acid polymer comprising polymerized units derived only from acrylic acid monomer is a homopolymer, while a polymer comprising polymerized units derived from acrylic acid, methacrylic acid and butyl acrylate is a copolymer.

“Polymerizable” as used to described a monomer or other molecule means that the monomer or other molecule has at least one carbon-carbon double bond and is capable of forming additional covalent bonds with other monomers or molecules of its kind, other polymerizable monomers or molecules, or polymers having polymerizable pendant groups, under normal polymerization conditions, and become incorporated in to the product polymer.

“Ethylenically unsaturated monomers” means molecules having one or more carbon-carbon double bonds, which renders them polymerizable. Monoethylenically unsaturated monomers have one carbon-carbon double bond, while multi-ethylenically unsaturated monomers have two or more carbon-carbon double bonds. As used herein, ethylenically unsaturated monomers include, without limitation, carboxylic acids, esters of carboxylic acids, carboxylic acid anhydrides, imides, amides, styrenes, sulfonic acids, and combinations thereof. Carboxylic acid monomers include, for example, acrylic acid, methacrylic acid, and salts and mixtures thereof. Sulfonic acid monomers include, for example, 2-(meth)acrylamido-2-methylpropanesulfonic acid, 4-styrenesulfonic acid, vinylsulfonic acid, 2-sulfoethyl(meth)acrylic acid, 2-sulfopropyl(meth)acrylic acid, 3-sulfopropyl(meth)acrylic acid, and 4-sulfobutyl(meth)acrylic acid and salts thereof.

Further examples of ethylenically unsaturated monomers include, without limitation, itaconic acid, maleic acid, maleic anhydride, crotonic acid, vinyl acetic acid, acryloxypropionic acid, methyl acrylate, ethyl acrylate, butyl acrylate, methyl methacrylate, ethyl methacrylate, butyl methacrylate and isobutyl methacrylate; hydroxyalkyl esters of acrylic or methacrylic acids such as hydroxyethyl acrylate, hydroxypropyl acrylate, hydroxyethyl methacrylate, and hydroxypropyl methacrylate; acrylamide, methacrylamide, N-tertiary butyl acrylamide, N-methyl acrylamide, N,N-dimethyl acrylamide; acrylonitrile, methacryionitrile, allyl alcohol, allyl sulfonic acid, allyl phosphonic acid, vinylphosphonic acid, dimethylaminoethyl acrylate, dimethylaminoethyl methacrylate, phosphoethyl methacrylate, phosphonoethyl methacrylate (PEM), and sulfonoethyl methacrylate (SEM), N-vinyl pyrollidone, N-vinylformamide, N-vinylimidazole, ethylene glycol diacrylate, trimethylotpropane triacrylate, diallyl phthalate, vinyl acetate, styrene, divinyl benzene, allyl acrylate, 2-acrylamido-2-methyl propane sulfonic acid (AMPS) and its salts or combinations thereof.

As used herein, the term “(meth)acrylic” includes acrylic acid and methacrylic acid. As used herein, the term “(meth)acrylates” includes esters of acrylic acid and esters of methacrylic acid.

The present invention relates to new monomer compositions which are polymerizable monomers having chelating functionality and are referred to hereinafter as “ethylenically unsaturated aminocarboxylate monomers.” The ethylenically unsaturated aminocarboxylate monomers of the present invention may have one or more of the following structures:

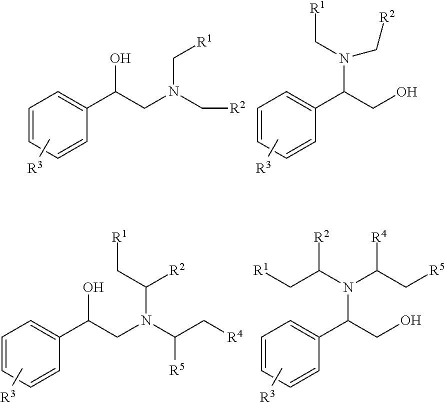

wherein R¹ is COOX¹, R² is COOX², R⁴ is COOX⁴ and R⁵ is COOX⁵ ; X¹, X², X⁴, X⁵ are each, independently, hydrogen or a mono- or polyvalent cation and the total charge on the monomer is zero; and R³ is a polymerizable ethylenically unsaturated group located at the ortho-, para-, or meta- substituted position of the benzene ring. In some embodiments, for example, X¹ and X² are each, independently, a mono- or polyvalent cation selected from the group consisting of: Na⁺, K⁺, NH₄⁺, organic ammonium ions, Ca²⁺ and Mg²⁺.

The present invention also provides a process for making the ethylenically unsaturated aminocarboxylate monomers which comprises reacting, in the presence of a phase transfer catalyst, iminodiacetic acid (IDA), iminodisuccinic acid, or a salt thereof, with a divinylbenzene monoepoxide (DVBMO) having the following structure:

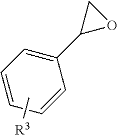

wherein R³ is a polymerizable vinyl (—HC═CH₂) group located at the ortho-, para-, or meta- substituted position of the benzene ring. Hereinafter, abbreviations for the possible structures of DVBMO in the ortho, para, and meta positions are o-DVBMO, p-DVBMO, and m- DVBMO. Note that “(o-, p-, m-)DVBMO” means one or more of the o-DVBMO, p-DVBMO, and m-DVBMO.

The iminodiacetic acid (IDA), iminodisuccinic acid (IDS), or salt thereof, and (o-, p-, m-)DVBMO may be reacted in any ratio, as is readily determinable by persons of ordinary skill. The process for making the ethylenically unsaturated aminocarboxylate in accordance with the present invention may be conducted at ambient temperatures. The foregoing process may be performed at a pH between 4 and 14, for example without limitation between 7 and 14.

The phase transfer catalyst is not particularly limited and various phase transfer catalysts useful for the above-described reaction are known to persons of ordinary skill in the relevant art. For example, without limitation, suitable phase transfer catalysts include benzyltrimethylammonium chloride, tetra-n-butylammonium bromide, methyltrioctylammonium chloride, hexadecyltributylphosphonium bromide, dimethyldiphenylphosphonium iodide, and methyltriphenoxyphosphonium iodide. For example, where (o-, p-, m-)DVBMO is provided for reaction with IDA, the reaction as demonstrated by the following reaction equation:

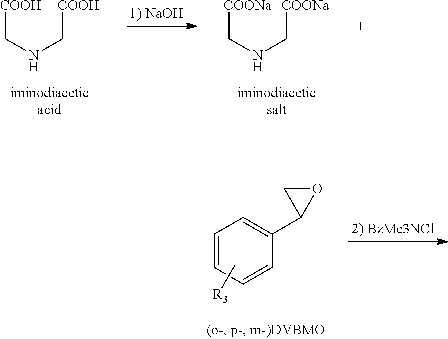

The foregoing reaction proceeds via opening of the epoxy ring and attachment of the IDA functional group to one of the carbon atoms of the opened epoxy ring. Thus, the ethylenically unsaturated aminocarboxylate monomers resulting from the foregoing reaction will have one or more of the following structures:

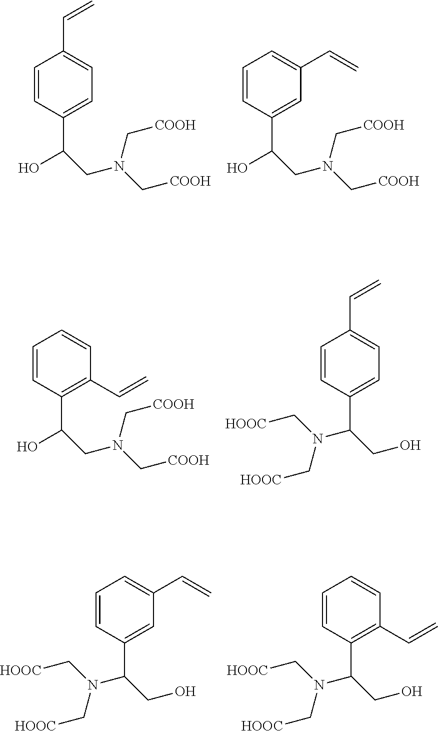 [SMILES: C=Cc1ccc(C(O)CN(CC(=O)O)CC(=O)O)cc1 ; C=Cc1cccc(C(O)CN(CC(=O)O)CC(=O)O)c1 ; C=Cc1ccccc1C(O)CN(CC(=O)O)CC(=O)O ; C=Cc1ccc(C(CO)N(CC(=O)O)CC(=O)O)cc1 ; C=Cc1cccc(C(CO)N(CC(=O)O)CC(=O)O)c1 ; C=Cc1ccccc1C(CO)N(CC(=O)O)CC(=O)O]

Of course, as will be recognized by persons of ordinary skill, the ethylenically unsaturated aminocarboxylate monomers of the present invention may be in their acidic form, as shown above, or they may be salts thereof, wherein one or more hydrogen atoms has been substituted for a mono- or polyvalent cation. The mono- or polyvalent cation may be selected from the group consisting of: Na⁺, K⁺, NH₄⁺, organic ammonium ions, Ca²⁺ and Mg²⁺.

As will be recognized by persons of ordinary skill in the relevant art, where ethylenically unsaturated aminocarboxylate monomers of the present invention are produced by reaction of iminodisuccinic acid (IDS) with (o-, p-, m-)DVBMO, multiple isomers will be present in the product mixture, similar to those shown above for the IDA-(o-, p-, m-)DVBMO reaction products.

The present invention also provides a polymer having chelating functionality which comprises units derived from the ethylenically unsaturated aminocarboxlate monomer and, optionally, other polymerizable monomers. Suitable other polymerizable monomers include one or more mono-or multi-ethylenically unsaturated monomers.

In some embodiments, the polymer according to the present invention is a homopolymer comprising 100%, by weight, of the ethylenically unsaturated aminocarboxylate monomer.

In other embodiments, the polymer according to the present invention may comprise at least 0.5%, by weight, of the ethylenically unsaturated aminocarboxylate monomer, for example, at least 5% by weight, or at least 20% by weight, or at least 30% by weight, or even at least 40% or 50%, by weight, of the ethylenically unsaturated aminocarboxylate monomer, based on the total weight of the polymer. Furthermore, the polymer according to the present invention may comprise up to 99.5%, by weight, of the ethylenically unsaturated aminocarboxylate monomer, for example, up to 95% by weight, or up to 90% by weight, or up to 80% by weight, or even up to 75% or 60%, by weight of the ethylenically unsaturated aminocarboxylate monomer, based on the total weight of the polymer.

Furthermore, the polymer according to the present invention may comprise at least 0.5%, by weight, of the one or more ethylenically unsaturated monomers, for example, at least 5% by weight, or at least 20% by weight, or at least 30% by weight, or even at least 40% or 50%, by weight, of the one or more ethylenically unsaturated monomers, based on the total weight of the polymer. Furthermore, the polymer according to the present invention may comprise up to 99.5%, by weight, of the one or more ethylenically unsaturated monomers, for example, up to 95% by weight, or up to 90% by weight, or up to 80% by weight, or even up to 75% or 60%, by weight of the one or more ethylenically unsaturated monomers, based on the total weight of the polymer.

The method of polymerization is not particularly limited and may be any method known, now or in the future, to persons of ordinary skill including, but not limited to, emulsion, solution, addition and free-radical polymerization techniques.

For example, in some embodiments, the polymer having chelating functionality in accordance with the present invention may be produced using one or more free-radical polymerization reactions. Among such embodiments, some involve the use of one or more initiators. An initiator is a molecule or mixture of molecules that, under certain conditions, produces at least one free radical capable of initiating a free-radical polymerization reaction. Photoinitiators, thermal initiators, and “redox” initiators, among others, are suitable for use in connection with the present invention. Selection of particular initiators will depend on the particular monomers being polymerized with one another and is within the capability of persons of ordinary skill in the relevant art. Examples of photoinitiators include benzophenone, acetophenone, benzoin ether, benzyl dialkyl ketones, and derivatives thereof. Examples of suitable thermal initiators are inorganic peroxo compounds, such as peroxodisulfates (ammonium and sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butylperpivalate, tert-butyl peroctoate, tert-butyl pemeodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azo compounds, such as 2,2′-azobisisobutyronitrile, 2,2′-azobis(2-methylbutyronitrile), 2,2′-azobis (2-methylpropionamidine)dihydrochloride, and azobis(2-amidopropane) dihydrochloride.

In some embodiments, thermal initiators can optionally be used in combination with reducing compounds. Examples of such reducing compounds are phosphorus-containing compounds, such as phosphorus acid, hypophosphites and phosphinates; sulfur-containing compounds, such as sodium hydrogen sulfite, sodium sulfite, sodium metabisulfite, and sodium formaldehyde sulfoxylate; and hydrazine. It is considered that these reducing compounds, in some cases, also function as chain regulators.

Another category of suitable initiators is the group of persulfates, including, for example, sodium persulfate. In some embodiments one or more persulfate is used in the presence of one or more reducing agents, including, for example, metal ions (such as, for example, ferrous ion), sulfur-containing ions (such as, for example, S₂O₃(=), HSO₃(−), SO₃(=), S₂O₅(=), and mixtures thereof), and mixtures thereof.

When initiator is used, the amount of all initiator used, as a weight percentage based on the total weight of all monomers used, is 0.01% or more; or 0.03% or more; or 0.1% or more; or 0.3% or more. Independently, when initiator is used, the ratio of the weight of all initiator used to the total weight of all monomers used is 10% or less, such as 5% or less; or 3% or less; or even 1% or less.

When initiator is used, it may be added in any fashion, at any time during the process. For example, some or all of the initiator may be added to the reaction vessel at the same time that one or more of the monomers is being added to the reaction vessel. In some embodiments, the initiator is added with a constant rate of addition. In other embodiments, the initiator is added with an increasing rate of addition, for example in two or more steps, where each step uses a higher rate of addition than the previous step. In some embodiments, the rate of addition of initiator increases and then decreases.

Production of the polymer having chelating functionality in accordance with the present invention may also involve the use of a chain regulator. A chain regulator is a compound that acts to limit the length of a growing polymer chain. Some suitable chain regulators are, for example, sulfur compounds, such as mercaptoethanol, 2-ethylhexyl thioglycolate, thioglycolic acid, and dodecyl mercaptan. Other suitable chain regulators are the reducing compounds mentioned herein above. In some embodiments, the chain regulator includes sodium metabisulfite. In some embodiments, the amount of chain regulator, as a percentage by weight based on the total weight of all monomers used, is 0.5% or more; or 1% or more; or 2% or more; or 4% or more. Independently, in some embodiments, the amount of chain regulator, as a percentage by weight based on the total weight of all monomers used, is 25% or less, such as 18% or less; 12% or less; 8% or less; or even 6% or less. In some embodiments, amounts of initiator larger that the amount needed to initiate polymerization can act as chain regulator.

Other suitable chain regulators include, for example without limitation, OH-containing compounds which are suitable for use in a mixture with water to form a solvent (such as isopropanol and propylene glycol). It is contemplated that, in some embodiments, the chain regulator is a component of the solvent and thus the chain regulator may be present in amounts larger than 25% by weight based on the total weight of all monomers used.

Chain regulator may be added to the reaction vessel in any fashion. In some embodiments, the chain regulator is added to the reaction vessel at a constant rate of addition. In some embodiments, the chain regulator is added to the reaction vessel at a rate of addition that increases or decreases or a combination thereof.

For each ingredient that is added to the reaction vessel, that ingredient may be added in pure form. Alternatively, an ingredient that is added to the reaction vessel may be added in the form of a solution in a solvent, in the form of a mixture with one or more other ingredient, or as a combination thereof (i.e., as a mixture with one or more other ingredient, where that mixture is dissolved in a solvent). The form in which any one ingredient is added to the reaction vessel may be chosen independently of the form in which any other ingredient is added to the reaction vessel.

Additionally, in some embodiments, the polymer having chelating functionality in accordance with the present invention may be produced by aqueous emulsion polymerization techniques. Generally, aqueous emulsion polymerization involves monomer, initiator, and surfactant in the presence of water. The emulsion polymerization may be performed by a method that includes the steps of adding one or more monomers (which may be neat, in solution, in aqueous emulsion, or a combination thereof) to a vessel that contains, optionally with other ingredients, water.

In accordance with the present invention, the one or more monomers used in the emulsion polymerization comprise at least one ethylenically unsaturated aminocarboxylate monomer, as described hereinabove. Additional monomers, selected from ethylenically unsaturated monomers, may also be included.

Initiators suitable for use in emulsion polymerization processes include, for example, water soluble peroxides, such as sodium or ammonium persulfate; oxidants, such as persulfates or hydrogen peroxide, in the presence of reducing agents, such as sodium bisulfite or isoascorbic acid and/or polyvalent metal ions, to form an oxidation/reduction pair to generate free radicals at any of a wide variety of temperatures; water soluble azo initiators, including cationic azo initiators, such as 2,2′-azobis(2-methylpropionamide)dihydrochloride. Furthermore, the emulsion polymerization process may employ one or more oil-soluble initiators, including, for example, oil-soluble azo initiators.

One or more surfactants may be employed. For example, at least one of the surfactants may be selected from alkyl sulfates, alkylaryl sulfates, alkyl or aryl polyoxyethylene nonionic surfactants, and mixtures thereof.

The use, application and benefits of the present invention will be clarified by the following discussion and description of exemplary embodiments of the present invention.

### EXAMPLES

### Example 1

### Synthesis of IDA-(p)DVBMO

To a 500 mL round bottom flask equipped with a magnetic stir bar and an addition funnel, 198 mL of Deionized water is added. The water is placed in an ice bath, and set to stir at a minimum of 300 rpm. Iminodiacetic acid (66.55 g) is added to the stirring water to form a slurry. 80 g of 50 wt % sodium hydroxide is slowly added to the slurry, and after approximately 20 minutes, the iminodiacetic acid is fully solubilized. 1.86 g of a phase transfer catalyst (Benzyltrimethylammonium chloride) is charged to the vessel and allowed to dissolve completely over approximately five minutes. During this time, 73.1 grams of (p)-DVBMO is charged to the addition funnel. The (p)-DVBMO is added drop wise to the stirring reaction mass, and when complete, allowed to stir at room temperature until the reaction mass transitions from two phases to a single phase. This is determined by visual observation, in which prior to completion, the reaction mass is hazy, and would separate into two distinct phases upon termination of stirring. Upon completion, the reaction mass is observed to be a clear solution, which is stable upon termination of stirring. This solution is stable to storage under ambient conditions and can be used as such.

In certain cases, solid monomer is required. To produce it from the above solution, sulfuric acid is added drop wise while stirring in order to adjust the pH of the solution, halting the flow of sulfuric acid when the pH is between 7-7.5. The solution was placed in an ice bath to promote crystallization. The crystals are isolated via filtration using a Buchner funnel and allowed to dry overnight before storage.

### Example 2

### Synthesis of Poly-(AA/IDA-VBE)

To a one liter round bottom flask, equipped with a mechanical stirrer, heating mantle, thermocouple, condenser and inlets for the addition of monomer, initiator and chain regulator is charged 38.46 grams of IDA-VBE, dissolved in a total of 100 g of deionized water. The mixture is set to stir and heated to 78° C. (+/−2° C.). In the meantime, a monomer solution of 45 grams of glacial acrylic acid is added to a graduated cylinder for addition to the flask. An initiator solution of 1.67 grams of sodium persulfate is dissolved in 15 grams of deionized water and added to a syringe for addition to the kettle. A chain regulator solution of 13.39 grams of sodium metabisulfite dissolved in 22.5 grams of deionized water is added to a syringe for addition to the kettle. A promoter solution of 7.75 grams of a 0.15% iron sulfate heptahydrate solution is added to a vial and set aside.

Once the kettle contents reached reaction temperature of 78° C., the promoter solution is added. After the reaction temperature recovered to 78° C., the monomer, initiator and CTA solutions are begun. The monomer feed is added over 90 minutes, CTA co-feed is added over 80 minutes, and initiator co-feed is added over 95 minutes at 78° C.

At the completion of the feeds, 5 grams of deionized water is added to the monomer feed vessel, as rinse. The reaction is held for 15 minutes at 78° C. In the meantime, the chaser solutions of 0.29 grams of sodium metabisulfite and 6.6 grams of deionized water is mixed and set aside, and 0.29 grams of sodium persulfate and 5 grams of deionized water is mixed and set aside.

At the completion of the hold, the above solutions are added linearly over 10 minutes and held for 20 minutes at 78° C. The chaser solution preparations are repeated and added to the kettle over 10 minutes, followed by a 20 minute hold.

At the completion of the final hold, cooling is begun with the addition of 47.50 grams of deionized water. At 50° C. or below a solution of 46.3 grams of 50% sodium hydroxide is added to an addition funnel and slowly added to the kettle, controlling the exotherm to keep the temperature below 65° C. Finally, 1.4 grams of a scavenger solution of 35% hydrogen peroxide is added to the kettle.

The reaction product is then cooled and packaged.

We claim:

1. A polymer having chelating functionality comprising units derived from
(a) an ethylenically unsaturated aminocarboxylate monomer having the following general formula: 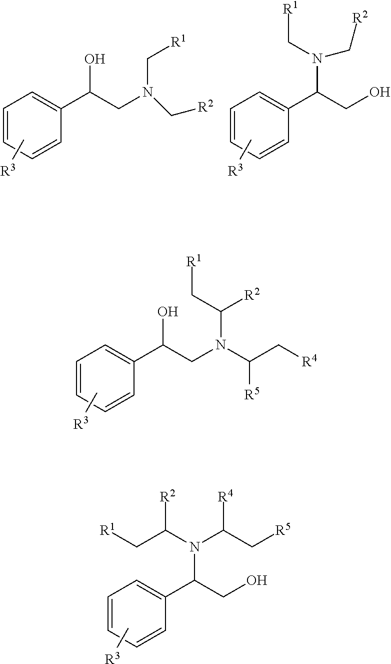
wherein R¹ is COOX¹, R² is COOX², R⁴ is COOX⁴ and R⁵ is COOX⁵; X¹, X², X⁴, X⁵ are each, independently, hydrogen or a mono- or polyvalent cation and the total charge on the monomer is zero; and R³ is a polymerizable ethylenically unsaturated group located at the ortho-, para-, or meta- substituted position of the benzene ring.

2. The polymer according to claim 1, wherein R³ is —CH═CH₂.

3. The polymer according to claim 1, wherein the mono- or polyvalent cation may be selected from the group consisting of: Na⁺, K⁺, NH₄⁺, organic ammonium ions, Ca²⁺ and Mg²⁺.

4. The polymer according to claim 1, further comprising:
(b) one or more ethylenically unsaturated monomers.

5. The polymer according to claim 4, wherein the one or more ethylenically unsaturated monomers selected from the group consisting of carboxylic acids, esters of carboxylic acids, carboxylic acid anhydrides, imides, amides, styrenes, sulfonic acids, and combinations thereof.

6. The polymer according to claim 4, comprising (a) 0.5-99.5%, by weight, of the vinyl aminocarboxylate monomer, and (b) 99.5-0.5%, by weight, of the one or more ethylenically unsaturated monomers, based on the total weight of the polymer.
